(19) United States
(12) Patent Application Publication
(10) Pub. No.: US 2007/0102103 A1
(43) Pub. Date: May 10, 2007

(54) Manufacturing method for printing circuit

(75) Inventor: Tom Ku, Hsinchu (TW)

Correspondence Address: BRUCE H. TROXELL, SUITE 1404, 5205 LEESBURG PIKE, FALLS CHURCH, VA, 22041, US

(73) Assignee: Klaser Technology Inc.

(21) Appl. No.: 11/267,496

(22) Filed: Nov. 7, 2005

(51) Int. Cl. B44C 1/17

(52) U.S. Cl. 156/233; 156/344

(57) ABSTRACT

A manufacturing method for a printing circuit uses an adhesive as a printing material to print a line pattern of a printing circuit on a carrier by means of printing, and then cause an adhesive to stick with a mother film with a release type metal to allow a part of the carrier with the adhesive to pull and attach itself with a metal film, and another part without the adhesive does not pull and attach itself with the metal film such that a metal line is formed on the carrier. The manufacturing method can simplify the manufacturing process of the printing circuit, the line fabrication is very fast, the production efficiency can be enhanced and the production cost is low.

### BACKGROUND OF THE INVENTION

1. Field of the Invention

The present invention relates to a manufacturing method for a printing circuit, and more particularly to a manufacturing method for a line in a printing circuit such as a line of an induction current for a radio frequency identification (RFID) and a line of a flexible printed circuit board (FPC).

2. Description of Related Art

One type of a general induction circuit for RFID is formed by winding a copper wire into a coil; the deficit thereof is that the outlook thereof must be manufactured to be cylinder-typed. Accordingly, the variation thereof is few, and the product cost is rather high comparing to other manufacturing processes. Another type thereof is formed by an etching method to stick; the manufacturing manner thereof is to electroplate a layer of metal on a plastic film, and after a mask is printed on a part of the surface of the metal film on which a line is desired to maintain, a unnecessary part thereof is etched to form an induction line. The deficit thereof is that the manufacturing processes are minute and complicated and rather not of environmental consciousness. Still another type is formed by a printing method; the manufacturing manner thereof is to add metal (e.g. silver and copper) powder into printing ink to cause the printing ink to be electrically conductive and then use it to print a necessary line directly on a plastic film. A merit thereof is that the manufacturing processes are simple and the working is convenient, but the deficit is that the price of the printing ink is too high.

A general copper foil used for manufacturing a flexible printing circuit board can be divided into a rolled anneal copper foil and an electro-deposited copper foil. Manufacturing a rolled anneal copper foil needs using a considerable expensive facility and passing through many copper plate rolling steps; the manufacturing processes are complex and the production cost is quite high. Manufacturing an electro-deposited copper foil is also complex and causes environmental pollution. If the factors of the environmental pollution want to be overcome, more rear stage processing facilities must be invested in; the production cost is considerably consumed.

Taiwan Patent No. 556,453 discloses a printing circuit board with an inlay-typed outer layer wire and the manufacturing thereof, it is characterized in that the outer layer wire is inlayed in a dielectric layer and stuck therewith on three faces; the manufacturing method thereof concludes: (a) providing a release type moldboard; (b) forming a metal layer on a surface of the separated type moldboard; (c) forming a photoresist layer on the metal layer; (d) forming a predetermined circuit pattern on the photoresist layer by means of exposure developing to expose a part of the metal layer out; (e) processing metallization to from a wiring layer on the exposed metal layer; (f) removing the photoresist layer to form the wiring layer with a predetermined circuit pattern on the separate moldboard; (g) pressing the separate type moldboard and a dielectric layer together to cause the wiring layer to be combined with the dielectric layer together closely and inlayer in the dielectric layer, and the metal layer is then combined with the surface of the dielectric layer; (h) removing the separate type moldboard; and (i) removing the metal layer on the dielectric layer.

The manufacturing processes of the above-mentioned Taiwan Patent are also very complex, and the production time and cost are very much consumed.

### SUMMARY OF THE INVENTION

For simplifying the manufacturing processes for a line in a general printing circuit and saving the production cost, the present invention is proposed.

The main object of the present invention is to provide a printing circuit, capable of simplifying the manufacturing processes and enhancing the production efficiency.

Another object of the present invention is to provide a manufacturing method for a printing circuit, the production cost thereof is low, it is unnecessary to use materials not to harm environment so that the manufacturing processes are more environmentally conscious.

Still another object of the present invention is to provide a manufacturing method for a printing circuit, capable of adjusting a printing line accompanying the need.

### BRIEF DESCRIPTION OF THE DRAWINGS

The present invention can be more fully understood by reference to the following description and accompanying drawings, in which:

FIGS. 1A to 1G are schematic views, showing manufacturing processes for a printing circuit of a preferred embodiment according to the present invention;

FIG. 2 is a schematic view, showing an induction antenna line with radio frequency identification on a carrier; and

FIG. 3 is a schematic view, showing a flexible printing circuit board with a line thereon.

### DETAILED DESCRIPTION OF THE PREFERRED EMBODIMENTS

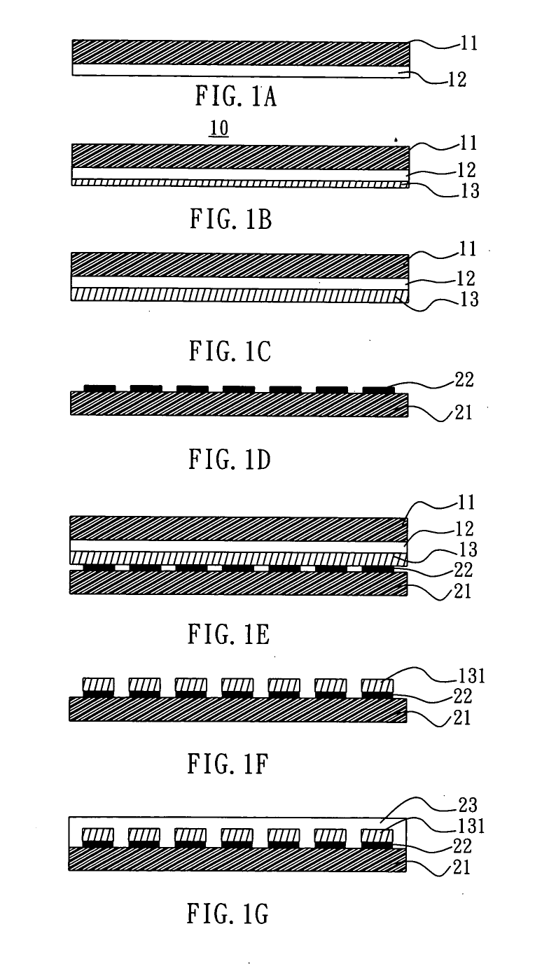

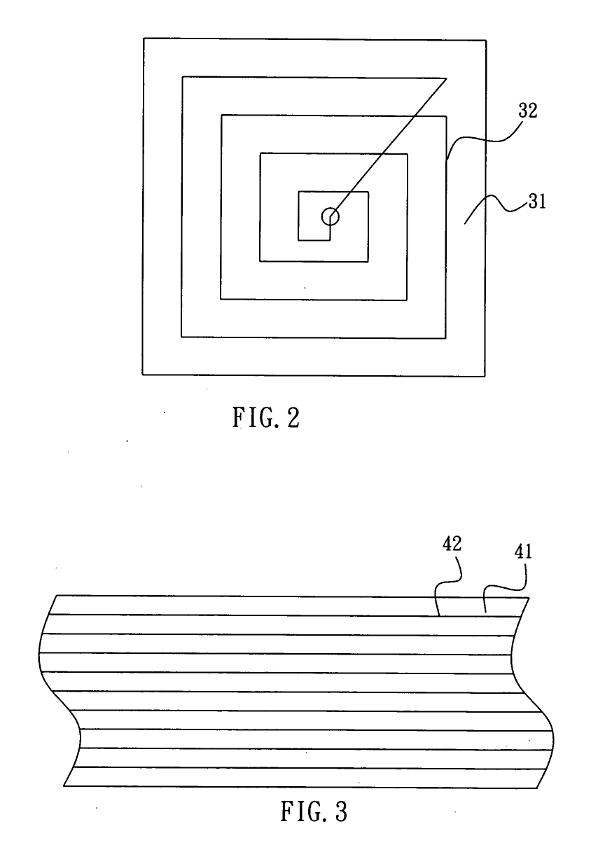

Please refer to FIGS. 1A to 1G. FIGS. 1A to 1G are schematic views show a manufacturing method for a printing circuit of a preferred embodiment according to the present invention. It comprises the following steps:
(1) spreading a release layer 12 with an effect of release on a plastic film 11, as FIG. 11A shows, thereafter, electroplating a metal layer 13 on a surface of the release layer 12 by utilizing a vacuum film-electroplating technology to form a mother film 10, as FIG. 1B shows;
(2) electroplating a metal layer 13, increasing the thickness of the metal layer 13, as FIG. 1C;
(3) utilizing an adhesive as a printing material to print a line with a predetermined pattern on a carrier 21 on which a printing circuit is to be fabricated, by printing the adhesive onto the carrier 21 to form an adhesive layer 22; the adhesive layer 22 forms a shape of the line with a predetermined pattern, as FIG. 1D shows;
(4) covering the metal layer 13 of the mother film on the carrier 21 to cause the metal layer 13 to be stuck on the carrier 21, as FIG. 1E shows; and solidifying the adhesive layer 22 to cause the carrier 21 to be stuck with the metal layer 13;
(5) separating the mother film with the carrier 21, a part of the carrier 21 with the adhesive then pulls and attaches itself with the metal film 13, and another part without the adhesive does not pull and attach itself with the metal film 13 such that a metal line 131 with a predetermined pattern is formed on the carrier 21, as FIG. 1F shows. and
(6) Spreading a layer of protection layer 23 on the metal line 131 of the carrier 21, as FIG. 1G shows.

In the steps mentioned above, the plastic film 11 can be a polyethylene (PE) film, a polycarbonate (PC) film or a polyethylene tetraphthate (PET) film; the material of the release layer 12 can be a silicon base resin or other material that is not firmly bounded with metal; the material of the metal layer 13 can be silver, copper or aluminum; the material of the carrier 21 can be a paper, a plastic film or flexible printing circuit board; the material of the adhesive layer 22 can be ultraviolet (UV) resin or adhesive; and the material of the protection layer 23 can be a series of acrylic or PU.

In Step (4), if the adhesive layer 22 is a UV resin, the adhesive layer 22 is directly illuminated with Ultraviolet light to cause it to be solidified; if it is another kind of adhesive, it is then dried with a heat source to cause it to be solidified.

In Step (6), the protection layer 23 is spread after the fabrication of the metal line 131 is complete, to prevent the electric characteristics of the metal line 31 from being changed owing to oxidation.

The fabricated metal line 131 according to the present invention can be a general inductive antenna with RFID. Because the metal line 131 used as an inductive antenna only receives or transmits signals, the power of transmission electric power is not large, the electroplating process in Step (2) is not needed. But, when the metal line 131 is used as a line on a flexible circuit board, because the electric power transmitted by the is larger, the thicker metal line 131 is needed, so that the electroplating process in Step (2) is needed to increase the thickness of the metal line 131 to increase the capability of the electric power transmission of the metal line 131.

The present invention is mainly to use an adhesive as a printing material to print a line pattern of a printing circuit on a carrier by means of printing, and then cause an adhesive to stick with a mother film with a release metal to allow a part of the carrier with the adhesive to pull and attach itself with a metal film, and another part without the adhesive does not pull and attach itself with the metal film such that a metal line is formed on the carrier. For example, an induction antenna line 32 with RFID is formed on a carrier 31 such as a paper or plastic film, as FIG. 3 shows; or a line 42 is formed on a carrier 41 such as a flexible printing circuit board, as FIG. 3 shows.

A general printing method is utilized to form a line pattern according to the present invention, the manufacturing processes can be simplified, the fabrication of a line is very fast, the production efficiency can be enhanced and the production cost is low. The printed line pattern is easier to be revised according to the present invention, the printing line can be quickly adjusted accompanying the need, and the material harmful to the environment need not be used, the environmental pollution is not caused so that it is rather environmentally conscious.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A manufacturing method for a printing circuit, comprising:
(1) utilizing an adhesive as a printing material to print a line with a predetermined pattern on a carrier on which a printing circuit is to be fabricated to form an adhesive layer; said adhesive layer forming a shape of said line with a predetermined pattern;
(2) causing said adhesive layer on said carrier to stick with a mother film with a release type metal film to attach said metal layer on said adhesive layer, and solidifying said adhesive layer;
(3) separating said mother film from said carrier, a part of said carrier with said adhesive then pulling and attaching itself with said metal film, and another part without said adhesive not pulling and attaching itself with said metal film such that a metal line with a predetermined pattern is formed on said carrier.

2. The manufacturing method according to claim 1, further comprising the following step:
Spreading a layer of protection layer on said metal line on said carrier after said Step (3).

3. The manufacturing method according to claim 2, wherein said mother film comprises a plastic film combined with a release type layer, a surface of said release type layer is combined with said metal layer.

4. The manufacturing method according to claim 2, wherein said mother film is made by utilizing vacuum film electroplating technology to electroplate a metal on said release layer after said release layer with a release effect is spread on said plastic film.

5. The manufacturing method according to claim 3, wherein said plastic film is one of a polyethylene film, a polycarbonate film and a polyethylene tetraphthate film.

6. The manufacturing method according to claim 5, wherein a material of said metal layer is one of silver, copper and aluminum.

7. The manufacturing method according to claim 6, wherein a material of said carrier is one of paper, plastic film and flexible printing circuit board.

8. The manufacturing method according to claim 7, wherein a material is one of ultraviolet resin and adhesive; a manner of solidification of adhesive layer is one of ultraviolet light illumination on said adhesive layer and heat source drying on said adhesive layer.

9. The manufacturing method according to claim 8, wherein a material of said protection layer is one of acrylic material and polyurethane material.

10. The manufacturing method according to claim 9, wherein said metal line is a line of an inductive antenna with radio frequency identification.

11. The manufacturing method according to claim 9, further causing said metal layer of said mother film to be electroplated to increase a thickness of said metal layer.

12. The manufacturing method according to claim 11, wherein said metal line is a line of a flexible circuit board.
